(19) United States
(12) Patent Application Publication
(10) Pub. No.: US 2004/0016723 A1
(43) Pub. Date: Jan. 29, 2004

(54) Welding or joining unit

(76) Inventor: Jurg Rohner, Zwillikon (CH)

Correspondence Address: BIRCH STEWART KOLASCH & BIRCH, PO BOX 747, FALLS CHURCH, VA, 22040-0747, US

(21) Appl. No.: 10/391,790

(22) Filed: Mar. 20, 2003

(30) Foreign Application Priority Data
Mar. 21, 2002 (EP) 02 405 217.7

(51) Int. Cl. B23K 11/10

(52) U.S. Cl. 219/86.8

(57) ABSTRACT

In a welding or joining unit (1), in particular for connecting workpieces having any desired spatial forms, at least two tools (12.1 to 12.[lacuna]) are arranged on a turret unit (3) which has a servo axis which can be programmed so as to be optimized with respect to time. Furthermore, the welding or joining unit (1) has a set-down unit (14) and a readjusting unit (19) and also a tool arranged thereon. By rotation of the turret unit (3), the tool (e.g. 12.1) designed for the desired type of connection is brought into position and the connection is produced.

### TECHNICAL FIELD

The invention relates to a welding or joining unit, in particular for connecting workpieces having any desired spatial forms, comprising at least two tools, a set-down unit for setting down the tools on the workpiece by open-loop or closed-loop control, and a readjusting unit for readjusting the tools.

### PRIOR ART

Workpieces of sheet metal and/or wire which are joined together from a plurality of parts are used as semifinished or finished products in many fields of application. These workpieces are mostly workpieces having any desired spatial form, in particular a nonplanar configuration. Furthermore, the workpieces are produced from materials which are the same or different but which can be welded to one another or joined together.

Various types of connections are often executed on one and the same workpiece. For example, the individual parts are at least spot-welded to one another or joined together in a spot-like manner, e.g. riveted to one another. In order not to have to provide a device for every type of connection to be produced, a plurality of welding tool units have been arranged side by side, for example, on a supporting unit of a welding machine, each individual unit of these units being equipped with a separate pneumatic system and being activated individually.

One possibility of connecting the individual parts of the workpieces to one another is “resistance forge welding”. In this case, workpiece parts in contact with one another are heated by an electric current flowing through. After the welding heat is reached, the workpiece parts are combined under pressure at their contact point. To protect the welding tools from overheating, they are cooled with a suitable coolant.

In the abovementioned method, force and current are conducted via appropriately shaped electrodes and the workpiece parts are connected to one another, for example in a spot-like manner. If a seam weld is to be produced, disk-shaped electrode rollers are used. Further known electrode shapes are bar-type electrodes or flat electrodes, e.g. for producing a projection weld. Normally, in this case, one of the electrodes is displaceable in the Z-axis and the opposite electrode—also called a backing electrode—is arranged in a fixed position.

The setting-down of the movable welding tools or electrodes on the workpiece is controlled with the set-down unit. Even at high production rates, the set-down pressure on the tool must not be too high, so that the latter is not excessively deformed when the electrode is set down.

With the arrangement of a plurality of welding tools arranged side by side, in addition to the axes (e.g. X-, Y- and Z-axes) which usually have to be taken into account, an additional axis is created which has to be taken into account when designing and programming the welding machine. This is because the welding tools have to be traversed along their axis on which they are arranged side by side before the weld is produced. Furthermore, during the positioning of the plurality of welding tools arranged side by side, and due to the spatial configuration of the workpieces, collisions may occur, which are to be taken into account when programming the welding machine and which additionally increase the programming effort.

### DESCRIPTION OF THE INVENTION

The object of the invention is to provide a welding or joining machine in which a plurality of tools are arranged on a welding or joining machine and, compared with the known solutions, even in the case of workpieces of complex spatial form, the time needed to avoid collisions is short and the programming effort is small.

The solution achieving the object is defined by the features of claim 1. According to the invention, a welding or joining unit is provided, in particular for connecting workpieces having any desired spatial forms, comprising at least two tools, a set-down unit for setting down the tools on the workpiece by open-loop or closed-loop control, and a readjusting unit for readjusting the tools. The at least two tools are arranged on at least one turret unit having a servo axis which can be programmed so as to be optimized with respect to time.

By the arrangement of the at least two tools on a rotatable turret unit, the programming becomes very much simpler. Since the production of the connection relative to the supporting construction of the welding or joining unit is always effected at the same location, optimum internal stability is also obtained. The desired tool is brought into position by rotating the turret unit. Thus the construction of the welding or joining unit having a plurality of tools becomes simpler and the possibility of collisions between the tools and the spatially configured workpieces during the positioning of the latter is reduced, for example compared with a welding machine having a plurality of welding tools arranged side by side. In this context, spatially configured or nonplanar workpieces essentially refer to any type of grid (e.g. baskets, oven grids, special grids, etc.) and three-dimensional metal sheets, for the most varied applications, which may have any desired spatial form.

The operation or programming of the welding or joining unit according to the invention is simpler compared with a solution having a plurality of joining tools arranged side by side, since the spatially offset arrangement of the tools does not have to be taken into account during the programming.

The turret unit is preferably NC-controlled (NC=numerically controlled). The NC control may be a computer-assisted control, a “CNC control”. With such controls and the associated drive (e.g. an electric motor), the tools arranged on the turret unit can be positioned exactly and in any desired manner. Unlike a solution with a ratchet drive, a controlled rotation of the turret unit clockwise or counterclockwise is possible. Depending on the function, further traversable elements of the welding or joining unit are NC- or CNC-controlled.

The turret unit may be arranged on the welding or joining unit in such a way as to be fixed or traversable relative to the movement of the joining tools in the Z-axis. If the turret unit, for example in an arrangement of welding tools, carries the “backing electrodes”, it is preferably fastened at the bottom and firmly to the welding or joining unit. An electrode traversable in the Z-axis is arranged opposite the backing electrode, i.e. above the arrangement of the latter, oriented by rotation of the turret unit. With the control of the set-down unit, the top electrode is moved onto the top side of the workpiece part to be welded. The set-down unit is then moved further by a predetermined distance in the direction of the backing electrode, the requisite applied pressure on the workpiece parts to be welded being produced with the readjusting unit. As soon as the set-down unit has produced the requisite pressure contact with the top workpiece part in this example, both electrodes are energized. After the desired welding heat at the contact point of the workpiece parts to be welded has been reached, the welding operation is ended. The top electrode is then retracted by a predetermined (preferably minimum) distance and the workpiece parts to be welded are brought into position for the next weld.

Even if the turret unit carries joining tools for example, it is preferably fastened at the bottom and firmly to the welding or joining unit. A backing tool traversable in the Z-axis is arranged opposite the joining tool, i.e. above the arrangement of the latter, oriented by rotation of the turret unit. With the control of the set-down unit, the top backing tool is moved onto the top side of the workpiece part to be connected. The set-down unit is then moved further by a predetermined distance in the direction of the joining tool, the requisite applied pressure on the workpiece parts to be connected being produced with the readjusting unit until the connection is made. The top backing tool is then retracted by a predetermined (preferably minimum) distance and the workpiece parts to be connected are brought into position for producing the next connection. During toxing or during projection embossing, the bottom tool must also be retracted slightly as a rule, so that the processed component can be moved in the plane.

The turret unit may also be arranged at the top—relative to the Z-axis—so that said turret unit is traversable in the Z-direction and the other tool is fixed. On the other hand, the top tool may also be fixed, i.e. non-displaceable, and the bottom tool may be traversable in the Z-direction, in which case the turret unit may also be arranged at the top or bottom in such an arrangement.

When the welding or joining unit according to the invention is used for producing welds, in addition to the feed line for current, each electrode must be provided with a feed line for a coolant (e.g. water), so that the electrode does not overheat. By the arrangement of at least two electrodes on the turret unit, only one main feed line for current and for coolant need be arranged for these electrodes. The distribution to the electrodes arranged on the turret unit is effected in the core of the turret unit. This arrangement simplifies the design of the welding or joining unit, for example compared with a welding machine having a plurality of welding tools arranged side by side.

With the welding or joining unit according to the invention, the most varied types of workpiece and in particular workpieces having any desired spatial form can be connected simply and quickly. Furthermore, a workpiece does not have to be inserted repeatedly into the welding or joining unit if a plurality of different types of connections are produced on this workpiece on a device. Furthermore, welds and joining and forming processes can be carried out on one and the same device.

The readjusting unit preferably acts on the turret unit as a whole. Therefore it is not necessary for each tool, e.g. welding tool, or each electrode to be provided with a readjusting unit. If the turret unit is formed on the side of the tool arranged in a fixed position and if it is arranged at the bottom relative to the Z-axis, the readjusting unit preferably acts on the top, movable tool. On the other hand, if the turret unit is displaceable in the Z-axis and arranged at the top, the readjusting unit preferably acts on the top turret unit. In a variant of this, the readjusting unit may also be arranged at the bottom if, for example, the bottom tool—always relative to the Z-axis—is designed to be displaceable. Since not every tool arranged on the turret unit is provided with a separate readjusting unit, the design cost and the conflicts associated with this are considerably reduced, for example compared with a welding machine having welding tools arranged side by side. In a welding machine having welding tools arranged side by side, each electrode pair, as in a welding machine having only one electrode pair, is provided with a readjusting unit.

In a preferred embodiment, two turret units are provided which carry tools assigned to one another. The two turret units are preferably arranged opposite one another on the Z-axis of the welding or joining unit. In accordance with the comments made above, one of the turret unit [sic]—usually the bottom one—is not traversable in the Z-direction, whereas the other turret unit is accordingly designed so as to be traversable in the Z-direction. The traversability mentioned here relates to the function of the infeed, the travel of the tools away from and toward one another (which is not to be confused with the function of the readjustment, i.e. the slight displacement of the tool during the actual joining process).

The two turret units, as in an embodiment with only one turret unit and a single opposite tool, may be oriented in such a way that the connection is produced in any desired direction different from the direction of the Z-axis.

The turret units each preferably have a drive which is NC- or CNC-controlled. Thus the turret units can be rotated independently from one another and therefore the individual tools can be positioned in accordance with the requirements. In a variant of this, the turret units are moved by a common drive.

The set-down unit is preferably controlled by an NC servo axis. Thus the setting-down operation of the tool with the set-down unit can be controlled in a more differentiated manner than that which is possible with a conventional control, for example via a pneumatic cylinder arrangement. The control of the set-down unit and the force acting on the workpieces to be connected can be regulated via the motor torque. In a variant of this, the NC control can be assisted by a proximity sensor or a position measuring system, this proximity sensor or position measuring system taking into account the geometrical conditions during the traverse of the movable tool. The NC control permits “soft” set-down of the tool on the top side of the workpiece parts to be connected, and undesirable deformations when the tool is set down are largely ruled out. If the traversable tool is a welding electrode, its wear as a result of the setting-down of the welding electrode on the top side of the workpiece parts to be welded is reduced.

A further advantage results from the fact that the traversable tool is not only traversable between two predetermined end positions when the workpiece parts to be connected are repositioned for producing the next connection. The infeed movement is effected in an optimum manner with respect to time by virtue of the fact that the set-down unit is traversed only precisely to the extent that the workpiece parts to be connected can be moved and positioned for the next connection. Thus higher cycle rates can be realized during the production of the workpieces than is possible with a conventional control. As an alternative to the controls described, the infeed axis may also be controlled hydraulically, piezoelectrically or by electric motor.

In an advantageous embodiment, at least one of the turret units preferably carries six tools which are different from one another, preferably welding electrodes. The number of tools present may vary depending on the geometrical dimensions of the welding or joining unit and on the configuration of the workpieces to be produced. The rotatability of the turret unit is preferably also ensured when the workpiece parts to be connected are inserted in the processing plane of the welding or joining unit. A large number of tools on a turret unit reduces the depth to which the tools plunge into the spatially configured workpieces.

With the arrangement of various types of tool and configurations of the welding electrodes on a turret unit, on one and the same welding or joining unit, without manually exchanging the tools, connections adapted to the type of tool and the configuration of the welding electrodes can be made on the workpiece to be processed without the workpiece parts to be connected having to be removed from the welding or joining unit during the change between the different types of connection.

If nuts are to be additionally welded onto the workpiece parts to be connected, an automatic feed of welding nuts is preferably coupled to the electrodes designed for this purpose. The welding nuts in turn preferably have a multi-channel feed. In this case, different welding nuts—preferably automatically and as a function of the correspondingly designed electrode—can be fed to the welding or joining unit and welded to the corresponding workpiece part.

In an embodiment of the welding or joining unit with two opposite turret units, the tools on both are shaped in such a way that corresponding tool pairs (e.g. electrode pairs) can be formed. With two NC-controlled motors arranged, preferably independently of one another, on the turret units, the turret units are rotated, so that the tools are positioned as a function of the connection to be produced.

If a certain type of connection is to be mainly produced on a workpiece, a plurality of tools matched to this type of connection can be provided. For example, on a welding unit according to the invention which does not produce types of connection other than welds, three electrodes for spot welds and in each case an electrode for other types of weld are in each case arranged on the turret units.

If only one type of connection is produced on the workpiece to be produced, all the tools—in accordance with the desired type of connection—are of the same design. In particular in the production of welds, the service life of the welding or joining unit and also the tip life of the electrodes can be substantially increased. If an electrode is worn down or contaminated, the turret star is rotated further and the next electrode at the periphery of the turret star is used for the further welds. The same applies to joining tools, which after a certain period of use can be exchanged by rotating the turret star.

The workpiece parts to be welded increasingly do not have a surface which is optimally prepared for the weld but are intentionally provided, for example, with a coating. In particular workpiece parts with a coated surface (e.g. with a slight phosphate coating or with a partly organic coating) are problematic. The transmission resistance between electrode and metal sheet increases as a result and the electrode is consequently subjected to increased wear. Impurities of the surfaces of the workpiece parts to be welded may also lead to wear of the electrode. A preferred possibility of countering the associated disadvantages with regard to the service life of the machine consists in providing a special dressing unit for subsequently dressing the tools during continuous production. The details of such an arrangement are described further below.

A plurality of identical electrodes on a turret may also possibly help to ensure that the individual electrode (on account of shorter use) is heated to a less pronounced extent. By the time the electrode originally used comes into use again, it has cooled down, as a result of the cooling carried out, to such an extent that it can be used again for further welds, which leads to a longer service life.

The tools of the welding or joining unit are, for example, welding tools, with which the workpiece parts to be connected are welded. In this case, their welding electrodes, in their form, may be designed, for example, as transversely or longitudinally oriented bar-type electrodes, spot welding electrodes, etc., or the electrodes may be designed for producing projection welds, for welding nuts to a workpiece, for roller seam welding, etc.

In addition to or instead of the welding tools, joining tools which join together the workpiece parts to be connected by, for example, clinching or toxing may be provided on the turret star.

(During clinching or toxing, the connection between the two workpieces—e.g. metal sheets—is produced by a local forming operation. A punch presses the sheet into the associated die, as a result of which a connection like a pushbutton is produced. In this case, it is not important whether the sheets are coated or surface-treated, have different thicknesses, are made of different materials—e.g. steel and aluminum—or whether an intermediate layer of foil or paper should be necessary.)

“Forming tools” are a further type of tool for the welding or joining unit. With these tools, the workpiece parts are formed at certain locations, at least in a spot-like manner, e.g. by embossing, deep drawing, bending, etc., so that the workpiece parts are mechanically connected to one another. An advantageous embodiment of the welding or joining unit has at least one embossing tool which produces a projection for a subsequent projection weld, the electrodes required for the projection weld being arranged on the same turret stars.

The readjusting unit is preferably pneumatically preloaded. For this purpose, a pressure bellows is preferably arranged between the set-down unit and the tool arrangement. If the tool has been set down with the set-down unit on the top side of the workpiece parts to be connected, the set-down unit is moved further by a predetermined distance in the same direction. With the pressure bellows, the requisite pressure is exerted by the movable tool on the workpiece parts to be connected. The build-up of force in such an embodiment is constantly present and is already available whenever a start is made to producing the connection, e.g. during a welding operation. Due to this arrangement, the current can flow immediately between the electrodes as soon as the set-down unit has set down the traversable electrode on the corresponding surface. Thus the time for the entire welding operation is substantially shorter and a greater number of cycles can be achieved than in a welding or joining unit of the known type.

The pressure bellows may be provided with a pneumatic control, which can apply a varying pressure to the pressure bellows. The force acting on the tool can therefore be increased or reduced in a simple manner in accordance with the requirements.

Instead of a pressure bellows, a pressure cylinder having a piston arrangement may be used. The cylinder is located in a low-pressure position, in which the piston is positioned in the bottom region of the cylinder. Since the cylinder is fastened to the set-down unit, the piston/cylinder arrangement is pushed together by the continued movement of the set-down unit and the requisite applied pressure is built up. A further possibility is a preferably preloaded spring, which produces the requisite applied pressure on the tool when the latter is moved onto the workpiece with the set-down unit.

In a conceivable (but usually less advantageous) variant for producing a weld, the applied pressure can be increased during the heating of the workpiece parts to be welded. As soon as the workpiece parts have reached a predetermined temperature, compressed air is admitted to the pressure bellows. In this case, the pressure preferably increases abruptly in the pressure bellows. After completion of the pressing operation, the pressure bellows is relieved and, with the control of the set-down unit, the set-down unit is traversed together with the readjusting unit and the one part of the electrode arrangement, so that the workpiece parts to be welded can be repositioned for the next weld (“Kraft-Strom-Programm” [force-current program]) “Fertigungstechnik 1+2” [production engineering 1+2] (A. Markowski [lacuna].

The welding or joining unit preferably has a C-shaped supporting frame, on the ends of which, on the one hand, a turret unit or an individual electrode is arranged so as to be fixed or movable and, on the other hand, the set-down unit is arranged so as to be displaceable in the Z-direction with the readjusting unit and a second turret unit or only an individual tool (e.g. an electrode). The requisite feed lines for the current, the control, the coolant, etc., can be run to the devices arranged at the ends. At the same time, the requisite clearance space is created between the ends of the C-shaped supporting frame in order to largely freely move the workpiece to be processed in all three dimensions between the turret unit and the set-down unit. The C-shaped supporting frame provides for a compact welding or joining unit. The workpieces in this case are preferably handled with a robot.

The welding or joining unit preferably has three freely programmable NC axes in order to perform any desired spatial movements. With the freely programmable NC axes, the workpiece parts to be welded can be exactly approached and positioned and also precisely connected to one another. If the movements to be performed are predetermined and not just any spatial movements are required, the welding or joining unit may have less than three freely programmable NC axes.

The set-down unit is preferably activated in such a way that a minimum stroke is performed when the tools are being changed. By the NC control preferably used, the set-down unit can be traversed by a predetermined value which can be adapted in any desired manner. On the other hand, this value may be varied as a function of the configuration of the workpiece to be processed and of the tool used. The set-down unit is preferably controlled by regulating the force as a function of the motor torque. A further possibility is, for example, for the set-down unit to be controlled via sensors or position measuring systems connected to it and this can be effected in an automated manner. The traversed distance is optimized in the sense that only a fraction of the maximum possible stroke is covered between certain connecting operations. In other words: the workpiece-specific programming of the infeed movement is generally such that, within a production cycle, stroke movements of different magnitude are performed by the set-down unit between successive connections (e.g. welds). Thus a higher production run can be achieved than when the traversability of the set-down unit is designed for a maximum stroke, and the set-down unit only has to cover small distances.

This applies to all the movable components of the welding or joining unit, for which reason preferably all the movable parts of the welding or joining unit are NC-controlled. However, the welding or joining unit does not necessarily have to be provided with NC-controlled axes. It may be controlled like a conventional welding machine.

The welding or joining unit preferably has a dressing unit for reworking a selected, temporarily non-activated tool. For example, the electrodes, for ensuring the quality of the welded connection, have to be subsequently dressed after a certain period of use and as a function of the materials to be welded or of the surface coating of the workpieces. So that the welding or joining unit can continue to be operated without interruption during the subsequent dressing of the electrode, the welding or joining unit is equipped with a dressing unit. This dressing unit is arranged, for example, at the side of the turret unit. If an electrode has cooled down to a predetermined temperature due to the cooling, the dressing unit subsequently dresses the electrode tip, while at the same time another electrode executes the further welds on the workpiece to be produced. Thus the welding or joining unit according to the invention can continue to be operated without interruption as a result of the subsequent dressing of an electrode tip.

If the welding or joining unit has two turret units, a separate dressing unit is preferably assigned to each turret unit. These dressing units are preferably controlled independently of one another. However, it is also conceivable to arrange only one dressing unit for the welding or joining unit having two turret units, for example on a robot arm. The dressing unit is oriented in accordance with the tool to be worked.

If an electrode has been dressed several times, at least the cap of the electrode has to be exchanged. For this purpose, a cap-changing unit for exchanging the cap of an electrode is preferably arranged at the side of the turret unit of the welding or joining unit. The electrode cap to be exchanged is removed by the cap-changing unit and is replaced by a new one, preferably from an attached magazine. At the same time, another electrode arranged on the turret unit executes the further welds on the workpiece to be produced. Thus the welding or joining unit according to the invention can continue to be operated without interruption as a result of the exchanging of the cap of an electrode. Instead of or in addition to the cap-changing unit, a tool-changing unit may be provided which exchanges the entire tool (e.g. an electrode, a joining or forming tool) if required.

If the welding or joining unit has two turret units, a separate cap-changing unit or tool-changing unit is preferably assigned to each turret unit. These cap-changing units or tool-changing units are preferably controlled independently of one another. However, it is also conceivable (even if technically very complicated) to arrange only one cap-changing unit or tool-changing unit for the welding or joining unit having two turret units, for example on a robot arm. The cap-changing unit or tool-changing unit is oriented in accordance with the tool to be worked. Furthermore, one dressing unit each and one cap-changing unit or tool-changing unit each may be arranged on the same turret unit.

Further advantageous embodiments and combinations of features of the invention follow from the detailed description below and the patent claims in their entirety.

### BRIEF DESCRIPTION OF THE DRAWINGS

In the drawings used for explaining the exemplary embodiment:

FIG. 1 shows a perspective detail view of a turret unit according to the invention;

FIG. 2 shows a side view of a welding or joining unit with two turret units arranged opposite one another;

FIGS. 3a, b each show a schematic sketch of individual method steps of a welding operation;

FIGS. 4a, b, c show a schematic sketch of the tools and of a workpiece part for the embossing of welding projections; and

FIG. 5 shows a side view of a stationary welding or joining unit with two turret units arranged opposite one another and a robot arm for the spatial handling of the workpiece part.

The same parts in the figures are in principle provided with the same reference numerals.

### WAYS OF IMPLEMENTING THE INVENTION

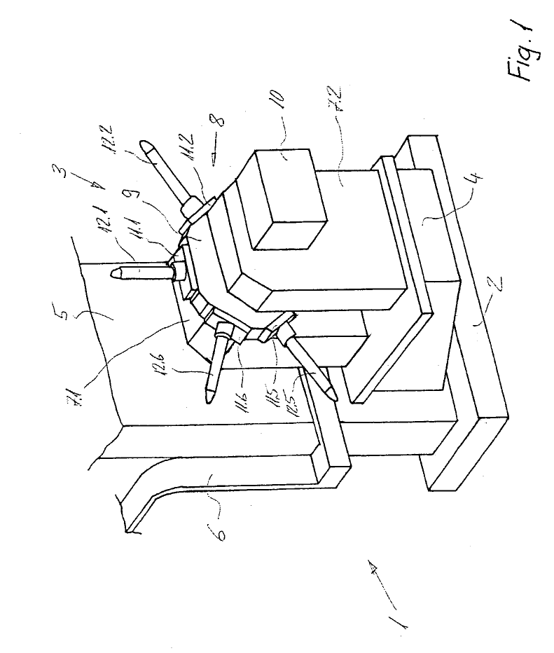

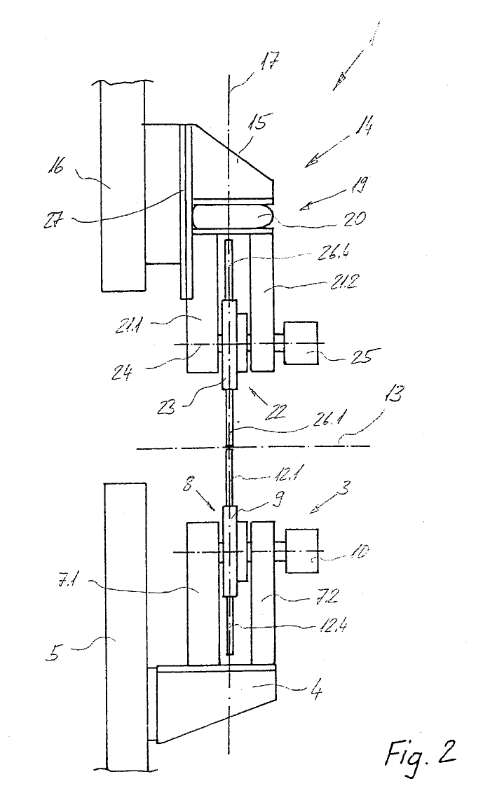

FIG. 1, in a perspective detail view, shows the bottom part 2 of a welding or joining unit 1 having a C-shaped supporting frame, on which a turret unit 3 according to the invention is arranged and which is equipped for producing welds. The turret unit 3 is arranged on a platform 4, which in turn is fastened in a fixed position to a vertical support 5, for example by means of screws and nuts. The position of the platform 4 in the Z-direction of the welding or joining unit 1 can preferably be adjusted, for example, in a grid or along an elongated hole, whereby the level of the processing plane can be adapted when required. The Z-direction is as a rule vertically oriented (cf. Z-axis 17 in FIG. 2). Via the end shown of the C-shaped supporting frame, the turret unit 3 is supplied with current via the feed line 6. In addition, a feed line (not shown here) for cooling water is provided in order to cool the welding tools of the turret unit 3. Due to the combined arrangement of electrodes 12.1 to 12.6 on the turret unit 3, the feed lines for the current and the cooling are concentrated in a central region, and the electrodes 12.1 to 12.6 can be supplied with current and coolant by a distribution in the turret unit 3 via this central region.

The turret unit 3 itself comprises two parallel, vertical holders 7.1 and 7.2, between which a turret star 8 is rotatably mounted. The turret star 8 has an essentially prismatic core 9, which in this exemplary embodiment has six flat side faces. The core is firmly connected to a shaft (not shown here), which is driven by an NC-controlled motor 10. Arranged on each respective side face of the core 9 is a base 11.1 to 11.6, to which the welding tools—here the electrodes 12.1 to 12.6—are preferably interchangeably fastened. On account of the geometrical dimensions, a total of six electrodes 12.1 to 12.6 are arranged on this turret star 8.

With the NC-controlled motor 10, the turret star 8 is rotated into the desired position before the welding operation, so that the electrode 12.1 used is preferably oriented perpendicularly to the processing plane. In this example, all the electrodes 12.1 to 12.6 arranged are designed for producing a spot weld and are shaped identically. In order to produce different welds on a workpiece, up to six differently shaped electrodes may also be arranged on the core 9 of the turret star 8. Arranged, for example, opposite the turret star 8 is a bar-type or flat electrode, which—as will be described below—is displaceable only in the Z-direction.

As will be shown below, a second turret unit 18 (cf. FIG. 2) may be arranged opposite the turret unit 3, this second turret unit 18 preferably having electrodes matched to the first turret unit 3. In such an embodiment, the electrode pairs required for producing the weld are formed with the electrodes of the first turret unit 3 and the second turret unit 18.

If, in addition to welds, other types of connection are to be capable of being executed on the welding or joining unit 1, the number of electrodes 12.1 to 12.6 is replaced by the number of corresponding tools. In this case, for example, a joining tool or forming tool can be arranged only on one of the turret units 3 or 18. Due to the preferred interchangeability of the individual tools, a large range of workpiece parts having different connections can be produced with one and the same welding or joining unit 1.

A side view of a welding or joining unit 1 having two turret units 3 and 18 arranged opposite one another for producing welds is shown in FIG. 2. The turret unit 3 shown below the processing plane 13 in the representation corresponds to the turret unit 3 which has already been described with respect to FIG. 1. The term “processing plane” 13 refers below to the plane which is formed by an X-axis and a Y-axis. The Z-axis 17 preferably runs perpendicularly to the processing plane 13. The set-down unit 14 lying above the processing plane 13 comprises a support 15 which, at the top part of the C-shaped supporting frame (not shown here), is fastened, e.g. firmly screwed, to a vertical support 16 such as to be displaceable at least in the Z-axis 17, e.g. along a guide rail 27. Via the C-shaped supporting frame or the vertical support 17 [sic], the turret unit 18 is supplied with current and cooling water via feed lines (not shown here).

Arranged between the support 15 and the turret unit 18 is the readjusting unit 19. The latter comprises a pressure bellows 20, to which, for example, compressed air is admitted and which exerts the necessary applied pressure on the turret unit 18 in order to produce the weld or the formed portion, as will be described below.

The turret unit 18 itself comprises two parallel, vertical holders 21.1 and 21.2, between which a turret star 22 is rotatably mounted. The turret star 22 is constructed essentially like the turret star 8. The turret star 22 has a prismatic core 23 which has six flat side faces. The core 23 is firmly connected to a shaft 24, which is driven by an NC-controlled motor 25. Arranged on each respective side face of the core 23 is a base, to which the welding tools—here the electrodes 26.1 to 26.6—are preferably interchangeably fastened. The number of electrodes 26.1 to 26.6 arranged on the turret star 22 preferably corresponds to the number of electrodes 12.1 to 12.6 arranged on the turret star 8. In this exemplary embodiment, in each case six electrodes 12.1 to 12.6 and respectively 26.1 to 26.6 are arranged on the turret stars 8 and 22 for a spot weld.

With the motor 25, the turret star 22 is rotated into the desired position before the welding operation. In this exemplary embodiment, all the electrodes 26.1 to 26.6 present are designed for a spot weld and are shaped identically. If, for example, electrodes of different configuration are arranged on the turret star 8, the electrodes 26.1 to 26.6 are designed for and are preferably matched to the electrodes 12.1 to 12.6 present on the turret star 8. As has already been explained with respect to the turret star 8, the welding or joining unit 1 may comprise only one turret star 8 or 22, opposite which, for example, a bar-type or flat electrode is arranged which is displaceable only in the Z-axis 17 or is fixed. Furthermore, other tools, e.g. for joining or forming processes, can be attached to the turret stars 8 and 22.

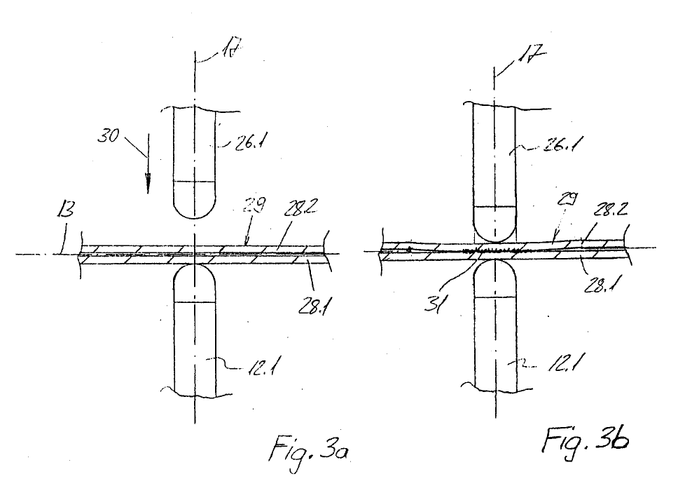

The function of the individual components of the welding or joining unit according to the invention for producing a weld is described below with reference to the schematic sketches (FIGS. 3a and 3b). In this example, two workpieces 28.1 and 28.2 are to be connected to one another by a plurality of spot welds.

The bottom turret unit (3 in FIG. 2)—insofar as necessary—is fed in advance up to the level of the processing plane 13 and is then held by position control in the Z-axis 17. Furthermore, the turret star (8 in FIG. 2) is rotated until the electrode 12.1, which serves as backing electrode, is perpendicular to the processing plane 13. The electrode 26.1 of the turret unit (18 in FIG. 2) is oriented perpendicularly to the processing plane 13 in accordance with the orientation of the electrode 12.1 by rotating the turret star (22 in FIG. 2), so that the electrodes 12.1 and 26.1 preferably come to lie on a line (here on the Z-axis 17). The electrode 26.1 is designed so as to be displaceable with the set-down unit (14 in FIG. 2) in the Z-axis 17.

In FIG. 3a, the electrode 26.1, at the start of the pressure welding operation, is in a top initial position, in which the workpiece parts 28.1 and 28.2 to be connected can be positioned between the electrodes 12.1 and 26.1. As soon as the workpiece parts 28.1 and 28.2 to be connected have been positioned in the processing plane 13, the electrode 26.1 is lowered with the NC-controlled set-down unit (14 in FIG. 2), for example along the guide rail (27 in FIG. 2), in the direction of the arrow 30 until the tip of the electrode 26.1 comes to lie on the top side 29 of the workpiece part 28.2. The set-down unit (14 in FIG. 2) is then moved further in the direction of the arrow 30 until the requisite applied pressure acts on the turret unit (18 in FIG. 2). The applied pressure which is immediately present is maintained during the entire welding operation by the pressure bellows (20 in FIG. 2).

If both tips of the electrodes 12.1 and 26.1 are in contact with the workpiece parts 28.1 and 28.2 to be welded—as is shown in FIG. 3b—the electrodes 12.1 and 26.1 are energized, in the course of which the workpiece parts 28.1 and 28.2 to be welded are heated at the contact point to the temperature required for the welding, and the welding is effected when the requisite temperature level has been reached. The pressure is maintained on the electrode 26.1 until the weld 31 is produced between the two workpiece parts 28.1 and 28.2. The set-down unit (14 in FIG. 2) is raised by the desired or requisite amount along the guide rail (27 in FIG. 2). This amount is selected in such a way that the workpiece parts to be welded can be repositioned for the next weld, but the traversed distance of the set-down unit (14 in FIG. 2) is preferably as small as possible. For example, the set-down unit (14 in FIG. 2) is traversed only by a fraction of the maximum possible stroke or only by a few millimeters. Consequently, the operation described is repeated for the further welds. During the individual method steps, the electrodes 12.1 to 12.6 and respectively 26.1 to 26.6 are continuously cooled with cooling water so that they do not overheat.

If the electrode tips of the electrodes used for the welding are worn or are contaminated by deposits of the material of the workpiece parts to be welded, the turret star 8 or 22 connected to the motor 10 or 25, respectively, is rotated further by the latter, clockwise or counterclockwise as required, by one or more electrodes. The method steps described with reference to FIGS. 3a and 3b are then repeated with the electrodes (e.g. with the electrodes 12.2 and 26.2) which are now oriented perpendicularly to the processing plane 13.

Instead of controlling the set-down unit (14 in FIG. 2) with the motor torque, the NC control may be coupled to a sensor, in particular if the material thickness or surface configuration of the workpiece parts 28.1 and 28.2 to be welded varies. With such an embodiment, the tip of the electrode 26.1 can be set down gently on the top side 30 [sic] as a function of the material thickness of the workpiece parts 28.1 and 28.2 to be welded.

“Dressing units” (not shown here) may be arranged, for example, laterally next to the turret stars 8 and 22, and these dressing units dress the electrodes 12.1 to 12.6 and respectively 26.1 to 26.6 if required and thus ensure a satisfactory quality of the welds produced for a longer period without the welding or joining unit 1 having to interrupt the production of the workpieces during the dressing operation. The frequency of this dressing operation depends primarily on the materials to be welded and on the service life [lacuna] the number of welds produced per electrode.

In addition to the dressing unit or as a separate device, a cap-changing unit may be arranged, for example, laterally next to the turret stars 8 and 22. After a certain number of dressing operations, at least the cap of the electrodes has to be exchanged. The cap-changing unit, like the dressing unit, may be integrated in the welding or joining unit 1 according to the invention. With such an arrangement, individual caps of the electrodes can be exchanged without the production being interrupted. Instead of the cap-changing unit, or in combination with it, a tool-changing unit may be present which exchanges the entire, worn-out tool and replaces it with a new tool. This operation can also take place without interrupting the production.

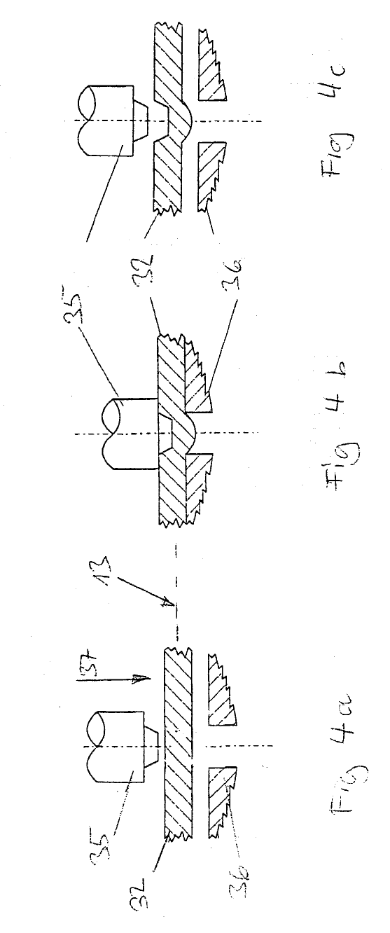

The sequence during the projection embossing with the welding or joining unit according to the invention is described below with reference to the diagrammatic representation in FIGS. 4a to 4c. Instead of the electrodes described hitherto, tools 35 and 36 which are suitable for producing a projection in a metal sheet are arranged on the turret stars or—if present—on the stationary unit.

The workpiece part 32 to be processed is put between the two tools 35 and 36. Similarity to what was described in connection with FIG. 3a with regard to the top electrode, the top tool 35 (punch) at the start of the embossing operation is in a top initial position which is at a sufficient distance from the bottom tool 36 (die) in order to position the workpiece part 32 between the tools 35 and 36. As soon as the workpiece part 32 to be processed has been positioned in the processing plane 13, the top tool 35 is lowered with the NC-controlled set-down unit (14 in FIG. 2), for example along the guide rail (27 in FIG. 2), in the direction of the arrow 37, and the lower tool is lifted in a comparable manner. For the forming, the requisite embossing pressure is then applied (FIG. 4b).

Once the forming has been completed, the set-down unit (14 in FIG. 2) is raised (FIG. 4c) by the desired or requisite (preferably minimum) amount along the guide rail (27 in FIG. 2). The workpiece can be repositioned and the next embossment can be made.

The procedure with clinching or toxing is similar, with the difference that the tool tips are shaped differently and that two workpieces are inserted one above the other between the tools and processed.

If other types of connection, e.g. welds, are to be produced on the workpiece parts, the turret star 8 or 22 connected to the motor 10 or 25, respectively, is rotated further by the latter, clockwise or counterclockwise as required, by one or more tools. As soon as the corresponding opposite electrodes are oriented, the method described in FIGS. 3a and 3b, for example, is repeated.

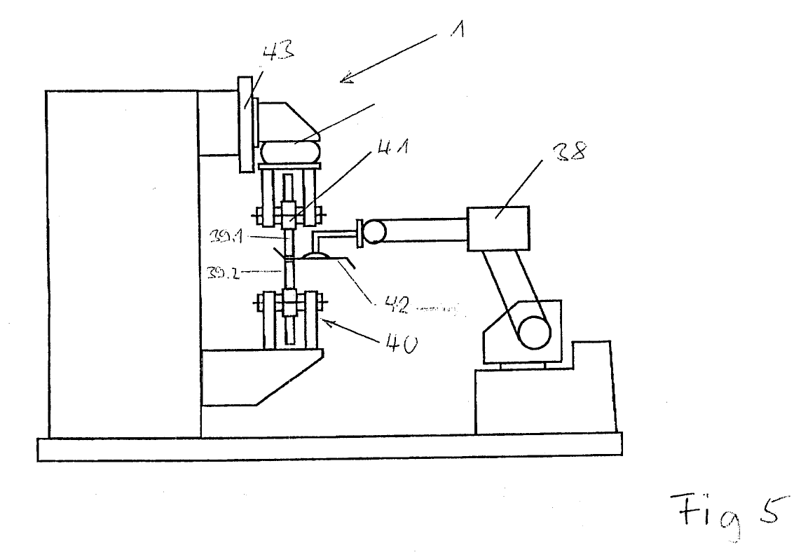

FIG. 5 shows a side view of a welding or joining unit having two turret units 40 and 41 arranged opposite one another and a robot arm 38. Instead of a processing table, the table surface of which essentially forms the processing plane (13 in FIGS. 2, 3 and 4), the workpiece parts 42 to be connected can be inserted into the welding or joining unit 1, positioned and, after a connection has been produced, repositioned by means of a robot arm 38. Such a robot arm 38 may have, for example, six axes and can thus move the workpiece to be produced largely freely. The freedom of motion is restricted only by the construction of the welding or joining unit 1 or by its positioning relative to the robot arm 38. The Z-axis 43 permits the infeed movement with the desired stroke. This allows for greater flexibility than there is in the case of a processing table, since the workpiece parts to be connected can also be positioned at an angle between the tool pairs 39.1 and 39.2. Furthermore, the programming of the robot arm 38 may be effected by “teaching”, a factor which considerably reduces the programming effort compared with purely numerical programming. The robot arm 38 may be set up in such a way that a plurality of welding or joining units or intermediate stores are interlinked in the production sequence.

Instead of electrodes 12.1 to 12.6 and respectively 26.1 to 26.6 designed in the same way and other types of tools, different tool forms may be arranged on the turret stars 8 and 22. For example, three electrodes each for a spot weld, one electrode each for a nut weld and two, for example different, bar-type or flat electrodes each, for example for projection welds, are arranged on each turret star 8 or 22, respectively. Depending on the desired type of weld, the turret stars 8 and 22 can be positioned clockwise or counterclockwise by the NC control of the motors 10 and 25 without the workpiece parts to be welded—in this exemplary embodiment—having to be removed from the welding or joining unit 1. If two turret units 3 and 18 are arranged on the welding or joining unit 1, the tools on the corresponding turret stars 8 and 22 are preferably matched to one another in such a way that in each case tool pairs belonging together can be formed.

Furthermore, the readjusting unit 19, instead of a pressure bellows 20, may have one or more pressure cylinders which exert the desired applied pressure on the workpiece parts to be welded, for example by admission of compressed air or a hydraulic fluid.

In summary, it may be stated that, with the welding or joining unit according to the invention, workpieces having any desired spatial forms can be connected with connections of the same type or with different connections without a complicated construction of the welding or joining unit and without there being a considerable programming effort. Different types of connections (e.g. welded, joined-together or formed connections) can be carried out on a fixture in a simple manner.

1. Welding or joining unit, in particular for connecting workpieces having any desired spatial forms, comprising at least two tools (12.1 to 12.6 and 26.1 to 26.6 resp.), a set-down unit (14) for setting down the tools (12.1 to 12.6 and 26.1 to 26.6 resp.) on the workpiece by open-loop or closed-loop control, and a readjusting unit (19) for readjusting the tools (12.1 to 12.6 and 26.1 to 26.6 resp.), characterized in that the at least two tools (12.1 to 12.6 and 26.1 to 26.6 resp.) are arranged on at least one turret unit (8 [sic] or 22 [sic] resp.) having a servo axis which can be programmed so as to be optimized with respect to time.

2. Welding or joining unit according to claim 1, characterized in that the readjusting unit (19) acts on the turret unit (22) as a whole.

3. Welding or joining unit according to claim 1 or 2, characterized in that two turret units (3 and 18) are provided which carry tools (12.1 to 12.6 and 26.1 to 26.6 resp.) assigned to one another.

4. Welding or joining unit according to claim 1 or 2, characterized in that the set-down unit (14) is controlled by a servo axis which can be programmed by NC control.

5. Welding or joining unit according to one of claims 1 to 3, characterized in that at least one of the turret units (3 or 18, resp.) preferably carries six tools (12.1 to 12.6 and 26.1 to 26.6 resp.) which are different from one another.

6. Welding or joining unit according to one of claims 1 to 3, characterized in that at least one of the turret units (3 or 18, resp.) carries a plurality of identical tools (12.1 to 12.6 and 26.1 to 26.6 resp.).

7. Welding or joining unit according to claim 5 or 6, characterized in that the tools are welding tools (12.1 to 12.6 and 26.1 to 26.6 resp.) and/or joining tools.

8. Welding or joining unit according to one of claims 1 to 7, characterized in that the readjusting unit (19) is controlled pneumatically.

9. Welding or joining unit according to one of claims 1 to 8, characterized in that it has a C-shaped supporting frame, to the ends (2) of which the at least one turret unit (3) and the set-down unit (14) are attached.

10. Welding or joining unit according to one of claims 1 to 9, characterized in that it has three freely programmable NC axes in order to perform any desired spatial movements.

11. Welding or joining unit according to one of claims 1 to 10, characterized in that the set-down unit (14) is activated in such a way that a minimum stroke is performed when the tools (12.1 to 12.6 and 26.1 to 26.6 resp.) are being changed.

12. Welding or joining unit according to one of claims 1 to 11, characterized in that it has a dressing unit for reworking a selected, temporarily non-activated tool (12.1 to 12.6 or 26.1 to 26.6).

13. Welding or joining unit according to one of claims 1 to 12, characterized in that it has a cap-changing unit for exchanging a cap of a tool (12.1 to 12.6 or 26.1 to 26.6) and/or a tool-changing unit for exchanging a tool (12.1 to 12.6 or 26.1 to 26.6).
